(19) United States
(12) Patent Application Publication
(10) Pub. No.: US 2024/0176095 A1
(43) Pub. Date: May 30, 2024

(54) OPTICAL SYSTEM, IMAGING APPARATUS INCLUDING THE SAME, IN-VEHICLE SYSTEM, AND MOVING APPARATUS

(71) Applicant: CANON KABUSHIKI KAISHA, Tokyo (JP)

(72) Inventors: NAOTO DOUJOU, Tochigi (JP); KAZUHIKO KAJIYAMA, Tochigi (JP); KENTO SAITO, Saitama (JP)

(21) Appl. No.: 18/518,308

(22) Filed: Nov. 22, 2023

(30) Foreign Application Priority Data
Nov. 29, 2022 (JP) 2022-190034

(51) Int. Cl. G02B 7/02; G06F 3/14

(52) U.S. Cl. CPC G02B 7/021; G06F 3/1423

(57) ABSTRACT

An optical system includes a first lens and a second lens, at least one of which is a cemented lens. Outside respective effective regions of the first lens and the second lens, the first lens and the second lens are in contact with a lens or an interval holding member disposed between the first lens and the second lens. Following inequalities are satisfied:

0.96<D1/D2<1.04, and

0.96<D1/D3<1.04,

where maximum diameters of the first lens and the second lens are D1 and D2, respectively, and a maximum diameter of the lens or the interval holding member is D3.

### BACKGROUND

### Technical Field

The aspect of the embodiments relates to an optical system including a cemented lens, and is suitable for an image capturing apparatus used in, for example, an in-vehicle system or a monitoring system.

### Description of the Related Art

Japanese Patent Application Laid-Open No. 2007-155976 discloses an optical system with favorable optical properties.

### SUMMARY

According to an aspect of the embodiments, a system includes a first lens and a second lens, at least one of which is a cemented lens. The first lens and the second lens are in contact with a lens or an interval holding member disposed between the first lens and the second lens outside respective effective regions. Following inequalities are satisfied:

0.96<D1/D2<1.04, and

0.96<D1/D3<1.04,

where maximum diameters of the first lens and the second lens are D1 and D2, respectively, and a maximum diameter of the lens or the interval holding member is D3.

Further features of the disclosure will become apparent from the following description of exemplary embodiments with reference to the attached drawings.

### BRIEF DESCRIPTION OF THE DRAWINGS

FIG. 1 is a schematic view of the main part of an optical system according to a first example.

FIG. 2 is a schematic view of the main part of the optical system according to the first example.

FIG. 3 is a graph illustrating an aspheric shape of the object-side surface of a lens according to the first example.

FIG. 4 is a graph illustrating a modulated transfer function (MTF) curve of the optical system according to the first example.

FIG. 5 is a schematic view of the main part of an image capturing apparatus according to an exemplary embodiment.

FIG. 6 is a schematic view of a moving apparatus and the image capturing apparatus held by the moving apparatus according to the present exemplary embodiment.

FIG. 7 is a block diagram of an in-vehicle system according to the present exemplary embodiment.

### DESCRIPTION OF THE EMBODIMENTS

In typical optical apparatuses each including an optical system and a lens barrel that supports the optical system, the inner diameter of the lens barrel is set to be sufficiently larger than the outer diameters of its lenses at ordinary temperature in order to prevent breakage of the lenses due to contraction of the lens barrel at low temperature. In other words, there is space between the lenses and the lens barrel at ordinary temperature.

However, the space between the lenses and the lens barrel may cause a lens to be decentered or tilted.

The aspect of the embodiments is directed to reduction of the decentering and tilting of a lens in an optical system with favorable optical properties.

Hereinafter, an exemplary embodiment of the disclosure will be described with reference to the drawings. The drawings may be drawn on a scale different from the actual scale for the sake of convenience.

An optical system according to the exemplary embodiment of the disclosure includes a first lens and a second lens, at least one of which is a cemented lens, and the first lens and the second lens are in contact with a lens or an interval holding member disposed between the first lens and the second lens outside the effective regions of the first lens and the second lens. In addition, suppose the maximum diameters of the first lens and the second lens are D1 and D2, respectively, and the maximum diameter of the lens or the interval holding member is D3, inequalities (1) and (2), which will be described below, are satisfied. Such a configuration makes it possible to reduce the decentering and tilting of the lenses in the optical system with favorable optical properties.

The optical system according to the exemplary embodiment can achieve the effect of the disclosure as long as at least the above-described configuration is satisfied. For example, the optical system may have a configuration including a plurality of positive lenses, a configuration including a plurality of negative lenses, or a configuration including two or more cemented lenses. Each cemented lens is not limited to one composed of a pair of a positive lens and a negative lens, and may be one composed of three or more lenses. Further, an optical element that does not contribute to image formation of the optical system, such as an optical filter or a cover glass, may be disposed closer to an image plane than a lens (final lens) closest to the image plane of the lenses constituting the optical system.

### First Example

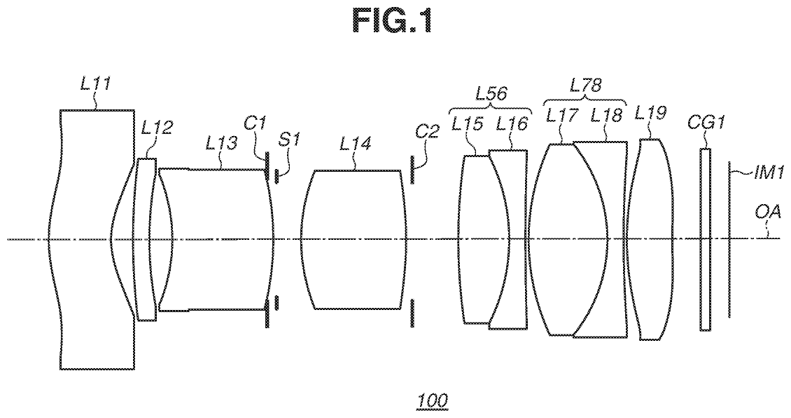

FIG. 1 is a schematic cross sectional view of the main part including the optical axis of an optical system according to a first example. In FIG. 1, the left side is the object side of the optical system (front side), and the right side is the image side (rear side). The optical system according to the present example is an image capturing optical system used in image capturing apparatuses, and the image capturing surface (sensor surface) of an image capturing element is disposed at the position of an image plane IM1. An optical block CG1 disposed on the object side of the image plane IM1 includes an optical element, such as an optical filter or a cover glass, which does not contribute to image formation of the optical system. In FIG. 1, a chain line represents an optical axis OA of the optical system. When the optical system according to the present example is applied to image capturing apparatuses or distance measuring devices, the light receiving surface (image capturing surface) of a light receiving element (image capturing element) is disposed at the position of the image plane IM1.

The optical system according to the present example includes a first negative lens L11, a second negative lens L12, a third negative lens L13, a first positive lens L14, a first cemented lens L56, a second cemented lens L78, and a final lens L19 disposed in order from the object side to the image side.

In the present example, an aperture stop S1 is disposed between the third negative lens L13 and the first positive lens L14. Such a configuration makes it possible to favorably correct aberration even at a low F-number.

The optical system according to the present example includes a first diaphragm C1. The first diaphragm C1 can adjust the F-number by blocking an outmost off-axis light flux (light flux reaching an outmost off-axis image height). Increasing the F-number in the outmost off-axis region of the angle of view allows reduction in decrease in the optical performance due to manufacturing error. It is sufficient that the first diaphragm C1 is capable of limiting an off-axis light flux (blocking a part of the off-axis light flux).

Further, in one embodiment, the first diaphragm C1 is to be disposed adjacent to the aperture stop S1. In addition, in another embodiment, the first diaphragm C1 is to be disposed on the object side of the aperture stop S1. The disposition of the first diaphragm C1 on the object side of the aperture stop S1 makes it possible to generate vignetting only from the intermediate region to the outmost off-axis region in the angle of view, allowing easy adjustment of the F-number in the range from the intermediate region to the outmost off-axis region in the angle of view.

Further, the optical system according to the present example includes a second diaphragm C2 different from the first diaphragm C1.

The second diaphragm C2 is disposed on the image side of the aperture stop S1 and the first diaphragm C1, and can adjust the F-number by blocking an outmost off-axis light flux (light flux reaching an outmost off-axis image height). In addition, in one embodiment, the second diaphragm C2 is to be disposed at a position where the interval between the second diaphragm C2 and the aperture stop S1 is sufficiently larger than the interval between the first diaphragm C1 and the aperture stop S1. Such a configuration allows easy adjustment of the F-number of the outmost off-axis region. It is sufficient that the second diaphragm C2 is capable of limiting the off-axis light flux (partially blocking the off-axis light flux).

The third negative lens L13 is a meniscus lens whose surface on its object side is a concave surface. The third negative lens L13 may be a cemented lens as long as the surface on its object side is a concave surface.

In the optical system according to the present example, the first negative lens L11 has an aspheric surface with a point of inflection in a cross section including the optical axis OA. Such a configuration makes it possible to easily widen the angle of view of the optical system with a reduced number of lenses constituting the optical system. In one embodiment, the object-side surface of the first negative lens L11 is an aspheric surface, and the first negative lens L11 is disposed on the object side farthest from the image side in the optical system.

In the present example, on the image side of the aperture stop S1, the first cemented lens L56 and the second cemented lens L78 are disposed in order from the object side to the image side. The disposition of a plurality of cemented lenses with a positive refractive power on the image side of the aperture stop S1 shares the positive refractive power, achieving an effect of reducing the occurrence of aberration. The first cemented lens L56 includes a positive lens L15 and a negative lens L16 cemented to the object-side surface of the positive lens L15. The second cemented lens L78 includes a positive lens L17 and a negative lens L18 cemented to the object-side surface of the positive lens L17.

The final lens L19 is a lens disposed closest to the image plane, and is a positive lens with an aspheric surface in the present example. In one embodiment, the final lens L19 is a lens with an aspheric surface in order to favorably correct curvature of field.

In the cemented lenses according to the present example, for example, adhesive is applied between each positive lens and the corresponding negative lens in order from the object side, so that the lenses closely adhere to each other. Although the cover glass CG is disposed between the sensor surface at the image plane IM1 and the final lens L19, the effect of the aspect of the embodiments can be obtained even if a spectroscopic filter, such as a wavelength selection filter, is also disposed. The presence or absence of a filter and a wavelength range does not affect the forms of the aspect of the embodiments.

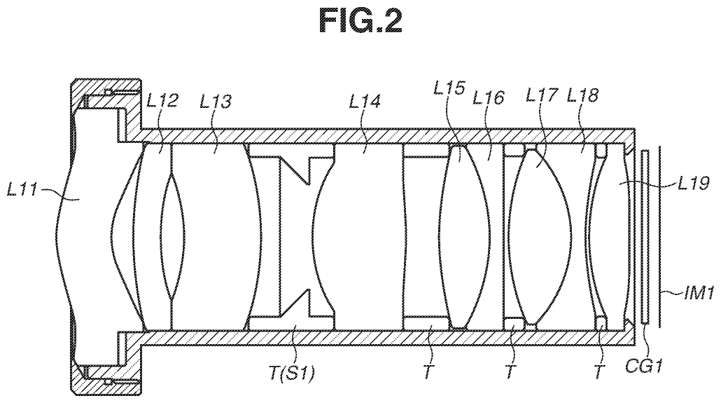

FIG. 2 is a schematic view of the main part of an optical apparatus including the optical system and a lens barrel according to the present example. In FIG. 2, the lens barrel and interval holding members T are illustrated in addition to the optical system. Each lens in FIG. 2 corresponds to the corresponding lens in FIG. 1. In FIG. 2, the maximum diameter of the second negative lens L12, the third negative lens L13, the first positive lens L14, the first cemented lens L56, the second cemented lens L78, and the final lens L19 is 12.0 millimeters (mm). Further, the minimum diameter of the first negative lens L11 is 12.0 mm. The maximum diameter and the minimum diameter of the lenses are not limited thereto. As long as at least the inequalities (1) and (2) to be described below are satisfied, the outer diameters of the lenses may be appropriately changed by design, and may include a slight deviation due to manufacturing error of a lens.

The interval holding members T include a spacer and a pressing ring, and are members for holding the positions of lenses or other elements. In FIG. 2, the interval holding member T located between the third negative lens L13 and the first positive lens L14 has a function similar to that of the aperture stop S1 in the optical system. The lenses constituting the optical system are in contact with each other outside their lens effective diameters, making it possible to enhance the effect of reducing the decentering and tilting of the lenses. In addition, this provides a compact optical apparatus that has a small space between the lens barrel and the lenses with little play. The lenses constituting the optical system may be in contact with each other via interval holding members. Further, the contact surfaces of the lenses and the interval holding members T may be bonded to be fixed by an adhesive member, such as an adhesive.

It is sufficient that the adhesive member is applied to partial regions on the contact surfaces. In addition, in one embodiment, the adhesive member used for adhesion and fixation have a property of being hardly peeled off at high humidity, high temperature, and low temperature.

The optical system according to the present example includes the first lens and the second lens. At least one of the first lens and the second lens is a cemented lens. Suppose that the maximum diameters of the first lens and the second lens are D1 and D2, and the maximum diameter of another lens or an interval holding member disposed between the first lens and the second lens is D3, in one embodiment, the two lenses contact the other lens or the interval holding member outside the effective regions, and the following inequalities (1) and (2) be satisfied.

0.96<D1/D2<1.04 (1)

0.96<D1/D3<1.04 (2)

With values below the lower limit values of the inequalities (1) and (2), the space between the lenses and the inner diameter of the lens barrel is increased, which prevents the occurrence of the relative decentering or tilting of a lens in the lens barrel from being reduced. Values above the upper limits of the inequalities (1) and (2) do not allow the space between the lenses and the inner diameter of the lens barrel at ordinary temperature to be secured.

In addition, in one embodiment, inequalities (1a) and (2a) below are to be satisfied, and in another embodiment, inequalities (1b) and (2b) are to be satisfied.

0.97<D1/D2<1.03 (1a)

0.97<D1/D3<1.03 (1b)

0.98<D1/D2<1.02 (2a)

0.98<D1/D3<1.02 (2b)

The difference in linear expansion coefficient between a lens barrel and a lens material may also increase the relative positional deviation of a lens in the lens barrel. In a conventional lens, the amounts of decentering and tilting of a lens may be increased based on the machining accuracy of the inner diameter of the lens barrel. In the optical system according to the present example, the lenses and the interval holding members T are in contact with each other outside the effective regions, making it possible to reduce the decentering and tilting of the lenses.

With decentering or tilting of a lens disposed adjacent to the aperture stop S1, the curvature of field of the optical system may become relatively large. In order to reduce the curvature of field of the optical system, in one embodiment, at least one of the first lens and the second lens is disposed adjacent to the aperture stop S1, and the above-described inequalities (1) and (2) be satisfied.

A lens disposed adjacent to the aperture stop S1 that satisfies the inequalities (1) and (2) makes it possible to secure the space between the lenses and the inner diameter of the lens barrel at ordinary temperature, and to reduce the curvature of field of the optical system.

Further, in order to reduce distortion aberration of the optical system, in one embodiment, at least one of the first lens and the second lens disposed adjacent to the aperture stop S1 have an aspheric surface. In this case, at least one of the first lens and the second lens with an aspheric surface disposed adjacent to the aperture stop S1 satisfy the above-described inequalities (1) and (2). At least one of the first lens and the second lens with an aspheric surface that satisfies the inequalities (1) and (2) described above makes it possible to reduce the decentering and tilting of each lens in the optical system, enhancing the effect of reducing distortion aberration.

The optical system according to the present example includes a third lens. In one embodiment, the third lens is in contact with another lens or an interval holding member outside its effective region and to satisfy an inequality (3) below, where the minimum diameter of the third lens is D4.

0.96<D1/D4<1.04 (3)

Furthermore, in one embodiment, an inequality (3a) below is to be satisfied, and in another embodiment, an inequality (3b) is to be satisfied.

0.97<D1/D4<1.03 (3a)

0.98<D1/D4<1.02 (3b)

The third lens that satisfies the inequality (3) makes it possible to secure the space between the lenses and the inner diameter of the lens barrel at ordinary temperature.

In one embodiment, the first lens among the lenses in the optical system is disposed farthest from the image plane IM1. For example, this allows the configuration of the optical system including a lens with a large lens diameter on the object side like the first negative lens L11 of FIG. 2. Such a configuration with reduced amounts of decentering and tilting of the lenses makes it possible to refract the light flux from a peripheral portion in radial directions of the light flux from the object side, toward the optical axis OA.

Due to the space between the lenses and the lens barrel at ordinary temperature, a part of the lenses of the optical system is decentered or tilted, which may cause comatic aberration of the optical system. In order to reduce comatic aberration of the optical system, in one embodiment, the lenses constituting the optical system have similar maximum diameters.

In order to reduce comatic aberration of the optical system, in one embodiment, the following inequality (4) is to be satisfied, where Dmax and Dmin are the maximum value and the minimum value of the maximum diameters of the lenses constituting the optical system and the interval holding members T. In the present example, the maximum and minimum values of the optical system excluding the first negative lens L11 are calculated.

1.00≤Dmax/Dmin<1.04 (4)

Values above the upper limit value of the inequality (4) do not allow the space between the lenses and the inner diameter of the lens barrel at ordinary temperature to be secured.

Furthermore, in one embodiment, an inequality (4a) below is to be satisfied, and in another embodiment, an inequality (4b) is to be satisfied.

1.00≤Dmax/Dmin<1.03 (4a)

1.00≤Dmax/Dmin<1.02 (4b)

In addition, a relative inclination of a lens may cause astigmatism to occur in the optical system. In order to reduce the occurrence of astigmatism of the optical system, in one embodiment, the contact surfaces of a lens and the corresponding interval holding member are in contact with each other be flat surfaces. If a part (partial region) of the contact surfaces between a lens and the corresponding interval holding member are flat surfaces, it is possible to reduce the relative inclination of the lens. Further, a region where a lens and the corresponding interval holding member are in contact with each other be a plane perpendicular to the optical axis. Such a structure can enhance the effect of reducing the relative inclination of a corresponding lens.

The above-described optical system may constitute an optical apparatus. The optical apparatus consists of the above-described optical system and the lens barrel that supports the optical system. The decentering and tilting of a lens occur due to the space between the lenses and the lens barrel at ordinary temperature. The space between the lenses and the lens barrel is set based on the difference in linear thermal expansion coefficient between the material of the lens barrel and the materials of the lenses. For example, with a combination that has a large difference in linear expansion coefficient, such as a combination of a lens barrel made of metal and the lenses made of glass, a remarkable effect is achieved. Suppose that a linear expansion coefficient of the lens barrel material at temperatures of −30 to 70° C. is αT [10⁻⁶/° C.], and the minimum value of linear expansion coefficients of the materials of the lenses included in the optical system at temperatures of −30 to 70° C. is αL [10⁻⁶/° C.], in one embodiment, the following inequality (5) is satisfied.

2.00<|αT−αL|<30.0 (5)

With values below the lower limit of the inequality (5), the difference in linear expansion coefficient between the material of the lens barrel and the materials of the lenses is small, and the space between the lenses and the lens barrel can be reduced at ordinary temperature, so that the effect of reducing the decentering and tilting of the lenses is lessened. On the other hand, with values above the upper limit of the inequality (5), the space between the lens and the lens barrel may be insufficient at high or low temperatures.

Furthermore, in one embodiment an inequality (5a) below is to be satisfied, and in another embodiment, an inequality (5b) is to be satisfied.

2.20<|αT−αL|<25.0 (5a)

2.50<|αT−αL|<20.0 (5b)

In the present example, the inner shape of the lens barrel is circular, and the outer shapes of the lenses constituting the optical system are also circular.

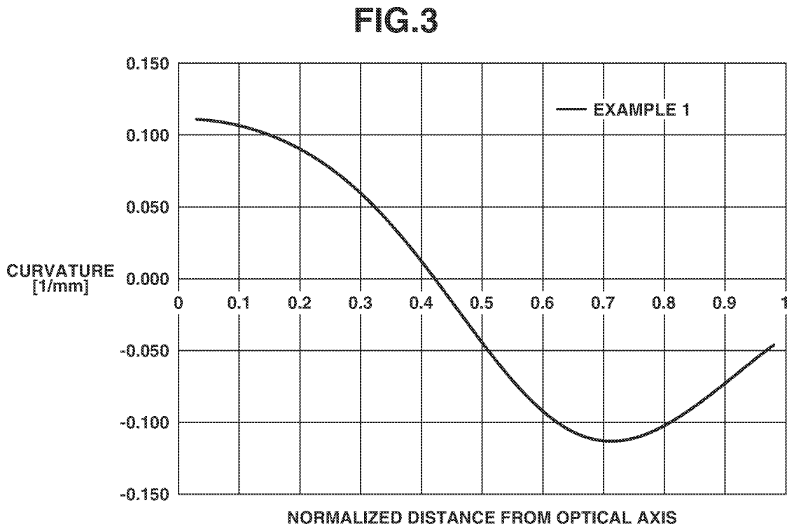

FIG. 3 illustrates an aspheric shape of the object-side surface of the first negative lens L11 according to the present example. In FIG. 3, the horizontal axis represents points on the object-side surface of the first negative lens L11 in a radial direction in a cross section including the optical axis OA, and the vertical axis represents curvatures [1/mm] of the object-side surface of the first negative lens L11. In short, FIG. 3 illustrates a graph in which curvatures at respective points on the object-side surface of the first negative lens L11 are plotted. The numerical values on the horizontal axis indicate distances (normalized distances) from the optical axis OA to respective points within the effective diameter of the object-side surface of the first negative lens L11 when the distance from the optical axis OA to the point of the effective diameter (maximum effective diameter) is normalized to be 1.

In one embodiment, the object-side surface of the first negative lens L11 is an aspheric surface such that a graph illustrating curvatures with respect to distances from the optical axis OA illustrated in FIG. 3 shows an extremum (minimum value) in addition to a point of inflection. As illustrated in FIG. 3, the graph according to the present example shows an extreme value. Thus, the difference in image formation magnification between a central region and a peripheral region of the optical system can be made conspicuous, and specifically, the image formation magnification of the central region can be made larger than that of the peripheral region, making it possible to improve the visibility of images for the user of an image capturing apparatus.

In addition, in one embodiment, the optical system according to the present example satisfies an inequality (6) below, where E is a normalized distance from the optical axis OA to the point corresponding to the extremum on the object-side surface of the first negative lens L11.

0.50≤E≤0.80 (6)

The inequality (6) defines an appropriate point of the extremum. By satisfying the inequality (6), it is possible to easily achieve both a reduction in size of the optical system and a wide angle of view. When the inequality (6) is not satisfied, it is difficult to appropriately set the image formation magnifications of the central region and the peripheral region.

Further, in one embodiment, the following inequality (6a) is to be satisfied, and in another embodiment, an inequality (6b) is to be satisfied.

0.52≤E≤0.78 (6a)

0.55≤E≤0.75 (6b)

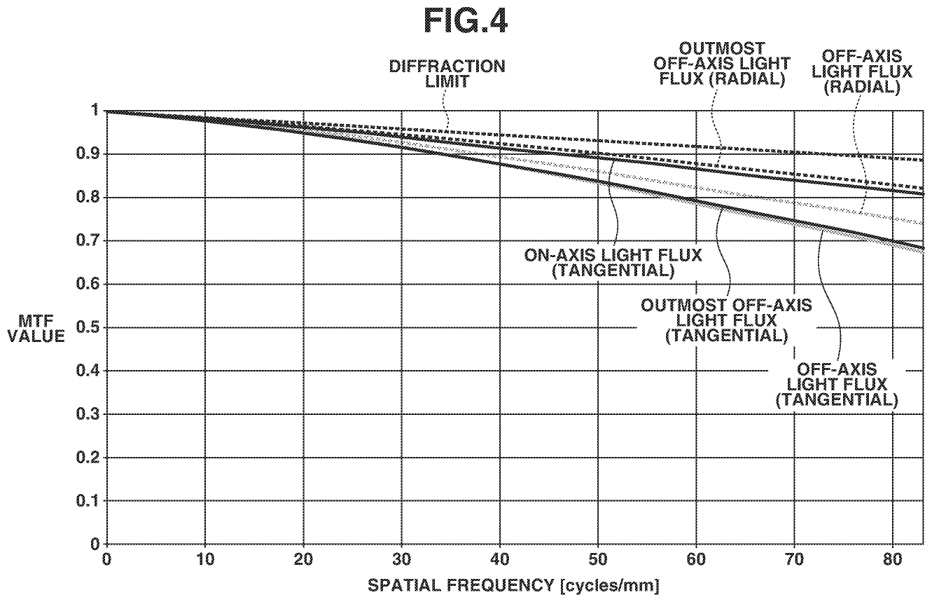

FIG. 4 is a graph illustrating a modulated transfer function (MTF) curve of the optical system according to the present example. In FIG. 4, the horizontal axis represents spatial frequencies [cycles/mm], and the vertical axis represents MTF values (contrast value). FIG. 4 illustrates a curve indicating a diffraction limit, an MTF curve for an on-axis light flux reaching an on-axis image height (central angle of view: 0°), an MTF curve for an off-axis light flux reaching an off-axis image height corresponding to a half angle of view of 30°, and an MTF curve for an outmost off-axis light flux reaching an outmost off-axis image height (half angle of view: 60°). In the present example, it is premised that an image capturing element having a pixel pitch of 3.0 micrometers (μm) is disposed at the image plane IM1. As illustrated in FIG. 4, the minimum value of the MTF values at a spatial frequency of 83 cycles/mm corresponding to the half value of the Nyquist frequency is about 68%.

When the optical system according to the present example is used in an image capturing apparatus, an image capturing element is disposed in addition to the optical system. The image capturing element is, for example, a charge coupled device (CCD) sensor or a complementary metal oxide semiconductor (CMOS) sensor.

An image capturing element with a plurality of light receiving portions in one pixel may be used as the image capturing element. Specifically, each of the plurality of pixels in the image capturing element may include a first light receiving portion and a second light receiving portion for receiving an optical image formed via the optical system according to the present example. With this configuration, for example, light incident on one pixel in the image capturing element is received by the first light receiving portion or the second light receiving portion depending on the incident angle. In other words, the first light receiving portion and the second light receiving portion receive light incident at different incident angles from each other. The incident angle of light is determined by which point on the pupil of the optical system according to the present example the light passes through. The pupil of the optical system is divided into two partial pupils by the two light receiving portions, and the two light receiving portions in one pixel acquire information obtained by observing the object space from visual points (pupil positions) different from each other.

A distance measuring device, such as an in-vehicle camera, can be configured with the above-described image capturing element, the optical system of the present example, and a processing unit to be described below.

### First Numerical Value Example

Hereinafter, a first numerical example corresponding to the above-described first example will be described. In the present numerical example, a surface number is the order of the respective optical surfaces when counted from the object surface. r [mm] represents the radius of curvature of the i-th optical surface, and d [mm] represents the interval (distance on the optical axis: surface interval) between the i-th optical surface and the (i+1)-th optical surface. Further, Fno denotes an aperture value, and the focal length is represented in millimeters (mm). However, the surface interval d is positive when directed to the image plane along the optical path and is negative when directed to the object side.

nd represents a refractive index of a medium between the i-th surface and the (i+1)-th surface with respect to d-line, and νd represents an Abbe number of the medium with respect to d-line. The Abbe number νd is a value defined by the following expression, where nF, nd, and nC are refractive indices for F-line, d-line, and C-line, respectively.

νd=(nd−1)/(nF−nC)

In the present numerical value example, an optical surface with a symbol “* (asterisk)” next to its surface number is an aspheric surface. Further, “E±X” means “10^{±X}”. Each optical surface in an aspheric shape in the present numerical value example has a rotationally symmetric shape about the optical axis OA, and is expressed by the following aspheric expression.

A sag amount Z [mm] in the optical direction indicating the shape of each aspheric surface is expressed by the following expression.

$$Z = \frac{( 1 / r ) {h}^{2}}{1 + \sqrt{1 - ( 1 + k ) {( 1 / r )}^{2} {h}^{2}}} + A {h}^{4} + B {h}^{6} + C {h}^{8} + D {h}^{10} + {Eh}^{12} + {Fh}^{14} \qquad [ Math . 1 ]$$

In the above aspheric surface expression, k is a conic constant, h is a distance [mm] from the optical axis in the radial direction, and A to F are aspheric surface coefficients of the fourth order term to the fourteenth order term, respectively. The second and subsequent terms indicate the sag amount (aspheric amount) of the aspheric component given to a reference spheric surface.

Here, only the aspheric coefficients of the fourth to fourteenth order terms are used, but aspheric coefficients of the sixteenth or higher order terms may be used as appropriate. In the present numerical example, when the optical surface forms an aspheric shape, the radius of curvature of the reference spherical surface is set as the radius of curvature of the optical system, and the radius of curvature satisfies the above-described inequality.

As the glass material according to the present example, an optical glass provided by, for example, OHARA Inc. or Hoya Corporation is used, but equivalent products provided by other companies may be used. In the present example, the material of the lens barrel is an aluminum-based alloy A5056 as an example. The material of the lens barrel is, however, not limited thereto. In the present numerical example, α [10⁻⁶/° C.] is the linear expansion coefficient of the lens material at temperatures of −30 to 70° C. In the optical system of the present example, αL [10⁻⁶/° C.] of the third negative lens L13 is 5.80, and αT [10⁻⁶/° C.] of the material A5056 of the lens barrel at temperatures of −30 to 70° C. is 24.30 [10⁻⁶/° C.].

Various data

| | |
|---|---|
| Center focal distance | 9.0 mm |
| Fno | 1.8 |
| Half angle of view | +60° |
| Design wavelengths | 486.1 to 656.27 nanometers |

Surface data

| | Surface number | r | d | α | Glass material |
|---|---|---|---|---|---|
| Object plane | 0 | ∞ | ∞ | | |
| L11 | 1* | 9.00 | 3.85 | 6.90 | MBACD12_HOYA |
| | 2* | 4.99 | 1.35 | | |
| L12 | 3 | 39.05 | 1.01 | 8.80 | STIH53W_OHARA |
| | 4 | 21.44 | 1.43 | | |
| L13 | 5 | −10.26 | 6.24 | 5.80 | SLAH60V_OHARA |
| | 6 | −17.03 | 0.20 | | |
| S1 | 7 | ∞ | 1.51 | | |
| L14 | 8* | 10.61 | 6.50 | 6.90 | MBACD12_HOYA |
| | 9* | −21.34 | 3.22 | | |
| L15 | 10 | 34.37 | 3.16 | 9.30 | SPHM53_OHARA |
| L16 | 11 | −11.27 | 1.00 | 7.50 | STIM35_OHARA |
| | 12 | 152.50 | 0.20 | | |
| L17 | 13 | 13.78 | 4.87 | 11.00 | SPHM52_OHARA |
| L18 | 14 | −9.27 | 1.00 | | STIH18_OHARA |
| | 15 | 72.37 | 0.20 | | |
| L19 | 16* | 15.89 | 2.80 | 6.90 | MBACD12_HOYA |
| | 17* | 19.79 | 1.54 | | |
| CG1 | 18 | ∞ | 1.00 | | NBK7_SCHOTT |
| | 19 | ∞ | 1.00 | | |
| Image plane | 20 | ∞ | — | | |

Aspheric coefficient

| | Surface | Surface | Surface | Surface | Surface | |
|---|---|---|---|---|---|---|
| | number 1 | number 2 | number 8 | number 9 | number 16 | number 17 |
| r | 9.000 | 4.990 | 10.612 | −21.336 | 15.893 | 19.789 |
| k | −9.034 | −0.831 | −0.490 | −3.026 | −10.000 | 6.923 |
| A | 4.846E−04 | −2.191E−03 | −7.605E−05 | 9.895E−05 | −4.879E−04 | −4.421E−03 |
| B | −6.792E−05 | −3.561E−05 | 1.473E−06 | 3.479E−06 | 6.844E−05 | 2.616E−04 |
| C | 2.122E−06 | 5.236E−06 | 6.085E−08 | −1.059E−07 | −3.803E−06 | −1.158E−05 |
| D | −3.334E−08 | −1.949E−07 | −6.557E−09 | 5.305E−09 | 1.142E−07 | 3.333E−07 |
| E | 2.764E−10 | 3.682E−09 | 3.545E−10 | −2.876E−10 | −1.761E−09 | −5.515E−09 |
| F | −9.671E−13 | −2.637E−11 | −6.105E−12 | 8.913E−12 | 8.837E−12 | 3.719E−11 |

The following table 1 illustrates values related to the inequalities for the optical system according to the first example described above. As illustrated in the table 1, the optical system according to the first example satisfies the inequalities.

TABLE 1

| | | First example |
|---|---|---|
| | D1 | 12.0 |
| | D2 | 12.0 |
| | D3 | 12.0 |
| | D4 | 12.0 |
| | Dmax | 12.0 |
| | Dmin | 12.0 |
| | αT | 24.3 |
| | αL | 5.8 |
| (1) | D1/D2 | 1.00 |
| (2) | D1/D3 | 1.00 |
| (3) | D1/D4 | 1.00 |
| (4) | Dmax/Dmin | 1.00 |
| (5) | \|αT − αL\| | 18.5 |
| (6) | E | 0.71 |
| (7) | f × sin(θmax)/y(θmax) | 1.63 |

[Image Capturing Apparatus]

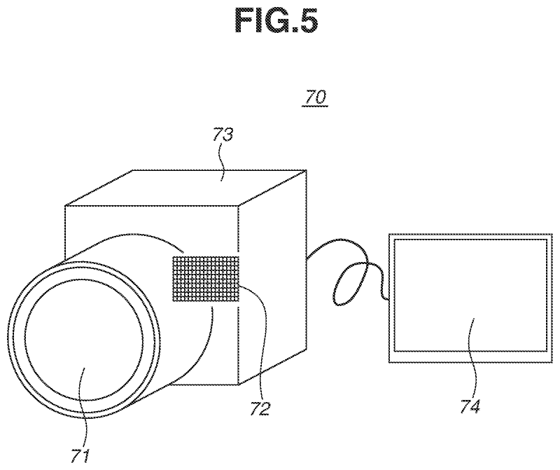

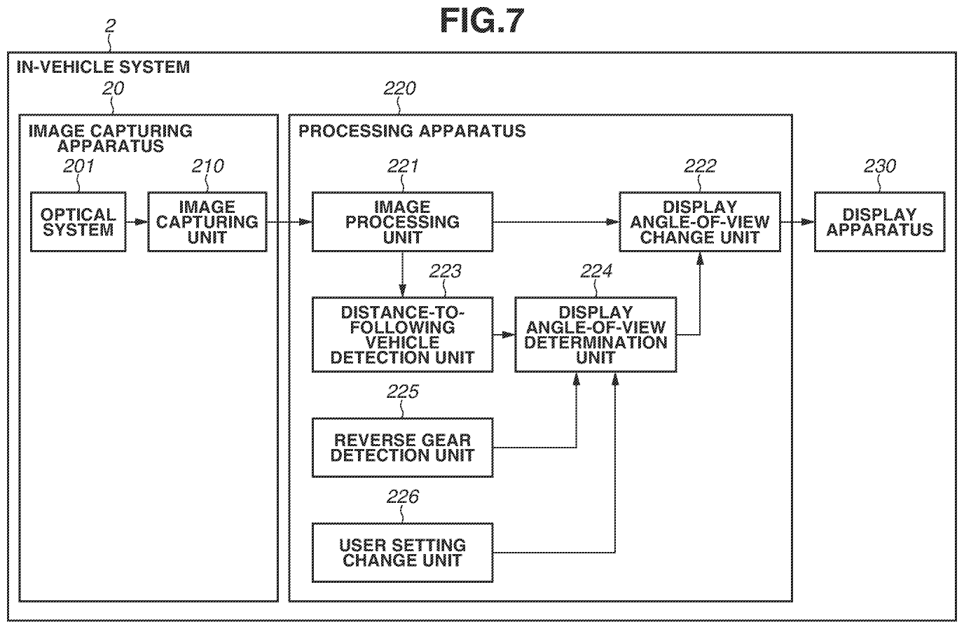

FIG. 5 is a schematic view of the main part of an image capturing apparatus 70 according to the exemplary embodiment of the disclosure. The image capturing apparatus 70 according to the present exemplary embodiment includes an optical system (image capturing optical system) 71 according to the above-described first example, a light receiving element 72 that photoelectrically converts an image of an object formed by the optical system 71, and a camera body (housing) 73 that holds the light receiving element 72. The optical system 71 is held by a lens barrel (holding member) and is connected to the camera body 73. As illustrated in FIG. 7, a display unit 74 for displaying images acquired by the light receiving element 72 may be connected to the camera body 73. As the light receiving element 72, an image capturing element (photoelectric conversion element), such as a CCD sensor or a CMOS sensor, can be used.

If the image capturing apparatus 70 is used as a distance measuring device, for example, an image capturing element (image capturing surface phase difference sensor) with pixels capable of dividing a light flux from an object into two and performing photoelectric conversion can be employed as the light receiving element 72. When an object is on the front focal plane of the optical system 71, no positional deviation occurs between the images corresponding to the two divided light fluxes on the image plane of the optical system 71. However, when an object is at a position other than the front focal plane of the optical system 71, a positional deviation occurs between the images. In this case, the positional deviation between the images corresponds to the amount of displacement of the object from the front focal plane, and the distance to the object can be measured by acquiring the amount of a positional deviation between the images and the direction of the positional deviation using the image capturing surface phase difference sensor.

The optical system 71 and the camera body 73 may be attachable to and detachable from each other. In other words, the optical system 71 and the lens barrel may be configured as an interchangeable lens (lens apparatus). The optical system according to the above-described first example can be applied to various optical apparatuses, such as a telescope, binoculars, a projector (projection apparatus), and a digital copying machine, as well as an image capturing apparatus, such as a digital still camera, a silver halide film camera, a video camera, an in-vehicle camera, and a monitoring camera.

### In-Vehicle System

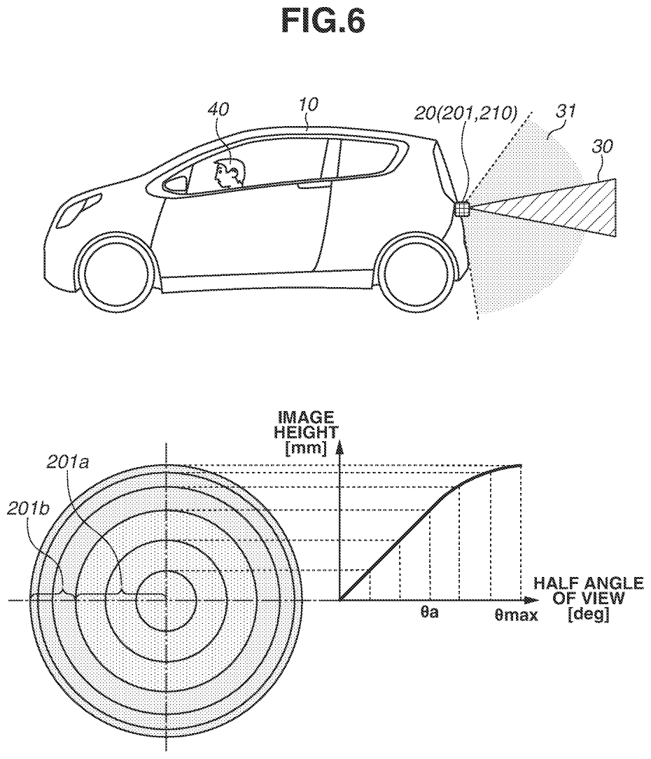

The upper diagram of FIG. 6 is a schematic view of a moving apparatus 10 and an image capturing apparatus 20 (in-vehicle camera) held by the moving apparatus 10 according to the present exemplary embodiment of the disclosure. The upper diagram of FIG. 6 illustrates a case where the moving apparatus 10 is an automobile (vehicle). The moving apparatus 10 includes an in-vehicle system 2 (driving assistant apparatus) (not illustrated) for assisting a user 40 (such as a driver or a fellow passenger) of the moving apparatus 10 using images acquired by the image capturing apparatus 20. In the present exemplary embodiment, a case in which the image capturing apparatus 20 is installed so as to capture behind the moving apparatus 10 is illustrated, but the image capturing apparatus 20 may be installed so as to capture in front of or on the sides of the moving apparatus 10. In addition, two or more image capturing apparatuses 20 may be installed at two or more places on the moving apparatus 10.

The image capturing apparatus 20 includes an optical system 201 according to the above-described first example and an image capturing unit 210. The optical system 201 is an optical system (different angle of view lens) in which a first angle of view (first field of view) 30 and a second angle of view (second field of view) 31 larger than the first angle of view 30 are different in image formation magnification. The image capturing surface (light receiving surface) of the image capturing unit 210 includes a first region that captures an image of an object included in the first angle of view 30 and a second region that captures an image of an object included in the second angle of view 31. In this case, the number of pixels per unit angle of view in the first region is larger than the number of pixels per unit angle of view in the second region other than the first region. In other words, the resolution in the first angle of view (first region) of the image capturing apparatus 20 is higher than the resolution in the second angle of view (second region).

Optical properties of the optical system 201 will now be described in detail. The left diagram of the lower diagrams of FIG. 6 illustrates an image height y [mm] at each half angle of view θ degrees [deg] on the image capturing surface of the image capturing unit 210 in a contour line shape. The right diagram of the lower diagrams of FIG. 6 is a graph illustrating a relationship (projection properties of the optical system 201) between each half angle of view θ and the image height y in the first quadrant of the left diagram.

As illustrated in the lower diagrams of FIG. 6, the optical system 201 is configured such that the projection property y(θ) is different between an angle of view smaller than a predetermined half angle of view θa and an angle of view equal to or larger than the predetermined half angle of view θa. Thus, the increased amount (resolution) of the image height y with respect to the half angle of view θ per unit is also different for each angle of view. A local resolution of the optical system 201 is represented by a differential value dy(θ)/dθ of the projection property y (θ) with respect to a half angle of view θ. The left diagram of the lower diagrams of FIG. 6 shows that the larger the interval between the contour lines of the image height y with respect to each half angle of view θ, the higher the resolution is. Further, the right diagram of the lower diagrams of FIG. 6 shows that the larger the slope of the graph of the projection property y(θ) is, the higher the resolution is.

In the left diagram of the lower diagrams of FIG. 6, a first region 201a that is the central region corresponds to the angles of view less than the half angle of view θa, and a second region 201b that is the peripheral region corresponds to the angles of view equal to and greater than the half angle of view θa. The angles of view less than the half angle of view θa corresponds to the first angle of view 30 in the upper diagram of FIG. 6, and the angles of view obtained by combining the angles of view less than the half angle of view θa and the angles of view equal to and greater than the half angle of view θa corresponds to the second angle of view 31 in the upper diagram of FIG. 6. As described above, the first region 201a is a high resolution and low distortion region, and the second region 201b is a low resolution and high distortion region.

In one embodiment, the value θa/θmax of the ratio of the half angle of view θa to the maximum half angle of view θmax is 0.15 or more and 0.35 or less, and in another embodiment, the value θa/θmax of the ratio of the half angle of view θa to the maximum half angle of view θmax is 0.16 or more and 0.25 or less. For example, in the above-described first example, since the maximum half angle of view θmax is 60°, in one embodiment that the value of the half angle of view θa is 9.0° or more and 21.0° or less, and in another embodiment, the value of the half angle of view θa is 9.6° or more and 15.0° or less.

Further, the optical system 201 is configured such that the projection property y(θ) in the first region 201a is different from f×θ(equidistant projection method) and is also different from the projection property in the second region 201b. In this case, the projection property y(θ) of the optical system 201 satisfies the following inequality (9).

1.00<f×sin(θmax)/y(θmax)≤1.90 (9)

The reduction of the resolution in the second region 201b with the inequality (9) satisfied makes it possible to provide a wide angle of view of the optical system 201. Further, in the first region 201a, the resolution can be made higher than that in the central region of a general fisheye lens employing the orthogonal projection method (y(θ)=f×sin θ). With values below the lower limit of the inequality (9), the resolution in the first region 201a becomes lower than that of the fisheye lens of the orthogonal projection method, or the maximum image height becomes larger, which leads to an increase in the size of the optical system, which is not desirable. With values above the upper limit of the inequality (9), the resolution in the first region 201a becomes too high, making it difficult to provide a wide angle of view equivalent to that of the fisheye lens of the orthogonal projection method, which makes it impossible to maintain favorable optical properties, which is also not desirable.

Further, in one embodiment the following inequality (9a) is to be satisfied, and in another embodiment the following inequality (9b) is to be satisfied.

1.00<f×sin(θmax)/y(θmax)≤1.80 (9a)

1.00<f×sin(θmax)/y(θmax)≤1.70 (9b)

As described above, with the small distortion and the high resolution of the optical system 201 in the first region 201a, a high definition image can be provided compared with the second region 201b. This can provide favorable visibility by setting the first region 201a (the first angle of view 30) to be a target region of the user 40. For example, as illustrated in the upper diagram of FIG. 6, with the image capturing apparatus 20 disposed on the rear portion of the moving apparatus 10, an image corresponding to the first angle of view 30 is displayed on an electronic room mirror, providing a natural perspective to the user 40 gazing at a following vehicle or other objects. On the other hand, the second area 201b (second angle of view 31) corresponds to a wide angle of view including the first angle of view 30. This, for example, allows driving assistance for the user 40 by displaying an image corresponding to the second angle of view 31 on an in-vehicle display while the moving apparatus 10 is traveling backward.

FIG. 7 is a functional block diagram for illustrating a configuration example of the in-vehicle system 2 according to the present exemplary embodiment. The in-vehicle system 2 is a system for displaying to the user 40 images obtained by the image capturing apparatus 20 disposed on the rear portion of the moving apparatus 10. The in-vehicle system 2 includes the image capturing apparatus 20, a processing apparatus 220, and a display apparatus (display unit) 230. As described above, the image capturing apparatus 20 includes the optical system 201 and the image capturing unit 210. The image capturing unit 210 includes an image capturing element, such as a CCD sensor or a CMOS sensor, photoelectrically converts an optical image formed by the optical system 201 to generate captured image data, and outputs the captured image data to the processing apparatus 220.

The processing apparatus 220 includes an image processing unit 221, a display angle-of-view determination unit 224 (determination unit), a user setting change unit 226 (first change unit), a distance-to-following vehicle detection unit 223 (first detection unit), a reverse gear detection unit 225 (second detection unit), and a display angle-of-view change unit 222 (second change unit). The processing apparatus 220 is, for example, a computer, such as a central processing unit (CPU) microcomputer, and functions as a control unit that controls the operation of constituent elements based on computer programs. At least one constituent element in the processing apparatus 220 may be implemented by hardware, such as an application specific integrated circuit (ASIC) or a programmable logic array (PLA).

The image processing unit 221 generates image data by performing image processing, such as wide dynamic range (WDR) correction, gamma correction, look up table (LUT) processing, and distortion correction on the captured image data acquired from the image capturing unit 210. The distortion correction is performed on captured image data corresponding to at least the second region 201b. This makes it easy for the user 40 to visually recognize an image when the image is displayed on the display apparatus 230, and improves the detection rate of a following vehicle by the distance-to-following vehicle detection unit 223. Further, the distortion correction may not be performed on captured image corresponding to the first region 201a. The image processing unit 221 outputs image data generated by performing the above-described image processing to the display angle-of-view change unit 222 and the distance-to-following vehicle detection unit 223.

The distance-to-following vehicle detection unit 223 acquires information on the distance to the following vehicle included in image data corresponding to the range of the second angle of view 31 excluding the first angle of view 30, using the image data output from the image processing unit 221. For example, the distance-to-following vehicle detection unit 223 can detect the following vehicle based on image data corresponding to the second area 201b in the image data, and calculate the distance to the user vehicle based on changes in the position and size of the detected following vehicle. The distance-to-following vehicle detection unit 223 outputs information on the calculated distance to the display angle-of-view determination unit 224.

Further, the distance-to-following vehicle detection unit 223 may determine the vehicle type of the following vehicle based on data relating to feature information, such as a shape and a color of each vehicle type, which is output as a result of machine learning (deep learning) based on images of a large number of vehicles. In this case, the distance-to-following vehicle detection unit 223 may output information on the vehicle type of the following vehicle to the display angle-of-view determination unit 224. The reverse gear detection unit 225 detects whether the transmission of the moving apparatus 10 (user vehicle) is at the reverse gear, and outputs the detection result to the display angle-of-view determination unit 224.

The display angle-of-view determination unit 224 determines which angle of view (display angle of view) of an image to be displayed on the display apparatus 230 is to be set to, the first angle of view 30 or the second angle of view 31, based on an output from at least one of the distance-to-following vehicle detection unit 223 and the reverse gear detection unit 225. Then, the display angle-of-view determination unit 224 performs output to the display angle-of-view change unit 222 based on the determination result. For example, the display angle-of-view determination unit 224 can determine to set the display angle of view to the second angle of view 31 when the value of the distance in the distance information is less than or equal to a certain threshold (for example, 3 meters (m)), and can determine to set the display angle of view to the first angle of view 30 when the value of the distance is greater than the certain threshold. Alternatively, when a notification that the transmission of the moving apparatus 10 is at the reverse gear is issued, the display angle-of-view determination unit 224 can determine to set the display angle of view to the second angle of view 31. In addition, the display angle-of-view determination unit 224 can determine to set the display angle of view to the first angle of view 30 when the transmission is not at the reverse gear.

Further, with the transmission of the moving apparatus 10 being at the reverse gear, the display angle-of-view determination unit 224 can determine to set the display angle of view to the second angle of view 31 regardless of the result of the distance-to-following vehicle detection unit 223. With the transmission of the moving apparatus 10 being not at the reverse gear, the display angle-of-view determination unit 224 can determine to set the display angle-of-view in accordance with the detection result of the distance-to-following vehicle detection unit 223. The display angle-of-view determination unit 224 may receive vehicle type information from the distance-to-following vehicle detection unit 223 to change a determination criterion for changing the angle of view in accordance with the vehicle type of the moving apparatus 10. For example, when the moving apparatus 10 is a large-sized car, such as a truck, the braking range is longer than that of a standard-sized car. In this case, the above-described threshold is set to be longer than that of the standard-sized car (for example, 10 m).

The user setting change unit 226 is used by the user 40 to cause the display angle-of-view determination unit 224 to change the criterion for determining whether the display angle of view is to be changed to the second angle of view 31. A determination criterion set (changed) by the user 40 is input from the user setting change unit 226 to the display angle-of-view determination unit 224.

The display angle-of-view change unit 222 generates a display image to be displayed on the display apparatus 230 in accordance with the determination result of the display angle-of-view determination unit 224. For example, when it is determined that the display angle of view is to be set to the first angle of view 30, the display angle-of-view change unit 222 cuts out a rectangular narrow angle image (first image) from image data corresponding to the first angle of view 30, and outputs the cut-out image to the display apparatus 230. When there is a following vehicle satisfying a predetermined condition in the image data corresponding to the second angle of view 31, the display angle-of-view change unit 222 outputs an image (second image) including the following vehicle to the display apparatus 230. The second image may include an image corresponding to the first region 201a. The display angle-of-view change unit 222 functions as a display control unit that performs display control for switching between a first display state in which the display apparatus 230 displays a first image and a second display state in which the display apparatus 230 displays a second image.

The display angle-of-view change unit 222 cuts out an image by storing image data output from the image processing unit 221 in a storage unit (memory), such as a random-access memory (RAM), and reading an image to be cut out from the storage unit. The area corresponding to the first image in image data is a rectangular area in the first angle of view 30 corresponding to the first region 201a. The area corresponding to the second image in image data is a rectangular area including the following car in the second angle of view 31 corresponding to the second region 201b.

The display apparatus 230 includes a display unit, such as a liquid crystal display or an organic electro-luminescence (EL) display, and displays a display image output from the display angle-of-view change unit 222. For example, the display apparatus 230 includes a first display unit as an electronic room mirror disposed on the upper side of a windshield of the moving apparatus 10 and a second display unit as an operation panel (monitor) disposed on the lower side of the windshield of the moving apparatus 10. This configuration allows the first image and the second image generated from the image data described above to be displayed on the first display unit and the second display unit, respectively. The first display unit may include, for example, a half mirror so as to be used as a mirror when not used as a display. The second display unit may also serve as, for example, a display of a navigation system or an audio system.

The moving apparatus 10 is not limited to a vehicle, such as an automobile, and may be a moving object, such as a ship, an aircraft, an industrial robot, or a drone. In addition, the in-vehicle system 2 according to the present exemplary embodiment is used to display images to the user 40, but is not limited thereto, and may be used for driving assistance, such as cruise control (including a function of following all vehicle speeds) or automatic driving. Further, the in-vehicle system 2 is not limited to the moving apparatus, and can be applied to various apparatuses using object recognition, such as an intelligent transport system (ITS).

### Modification

While the exemplary embodiment and example of the disclosure have been described above, the disclosure is not limited to the exemplary embodiment and example, and various combinations, modifications, and changes can be made within the scope of the gist of the disclosure.

For example, the optical system according to the above-described example is premised to be used in the visible region, and is configured to perform favorable aberration correction in the entire visible region, but the wavelength range in which aberration correction is performed may be changed as appropriate. For example, the optical system may be configured to perform aberration correction only in a specific wavelength range in the visible region, or may be configured to perform aberration correction in the wavelength range in the infrared region other than the visible region.

In addition, in the in-vehicle system 2 described above, the distance measuring device described above may be used as the image capturing apparatus 20. In this case, the in-vehicle system 2 may include a determination unit that determines the possibility of collision with the object based on information on the distance to an object acquired by the image capturing apparatus 20. In addition, a stereo camera including two image capturing units 210 may be used as the image capturing apparatus 20. In this case, even if the image capturing surface phase difference sensor is not used, it is possible to perform similar processing to the processing described above by using two pieces of image data acquired simultaneously by each of the image capturing units 210 in synchronization with each other. However, if the difference between image capturing times of the image capturing units 210 is known, the image capturing units may not be synchronized.

In addition, the above-described image capturing apparatus 20 may take a configuration in which the resolution in the second angle of view 31 (second region) is higher than the resolution in the first angle of view 30 (first region) as appropriate. In other words, the number of pixels per unit angle of view in the first region may be smaller than the number of pixels per unit angle of view in the second region excluding the first region. This configuration is suitable, for example, when the image capturing apparatus 20 is disposed at the position of a side mirror of a vehicle in order to capture an enlarged image of an object in the periphery of the angle of view rather than the center of the angle of view.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-190034, filed Nov. 29, 2022, which is hereby incorporated by reference herein in its entirety.

What is claimed is:

1. An optical system comprising a first lens and a second lens, at least one of which is a cemented lens,
wherein outside respective effective regions of the first lens and the second lens, the first lens and the second lens are in contact with a lens or an interval holding member disposed between the first lens and the second lens, and
wherein following inequalities are satisfied:
0.96<D1/D2<1.04, and
0.96<D1/D3<1.04,
where maximum diameters of the first lens and the second lens are D1 and D2, respectively, and a maximum diameter of the lens or the interval holding member is D3.

2. The optical system according to claim 1, wherein at least one of the first lens and the second lens is disposed adjacent to an aperture stop.

3. The optical system according to claim 2, wherein at least one of the first lens and the second lens includes an aspheric surface.

4. The optical system according to claim 1, wherein lenses including the first lens and the second lens constituting the optical system are in contact with each other outside effective regions of the lenses.

5. The optical system according to claim 4, wherein surfaces of the lenses including the first lens and the second lens constituting the optical system, the surfaces of which are in contact with each other outside the effective regions of the lenses, are flat surfaces perpendicular to an optical axis.

6. The optical system according to claim 5, wherein the contact surfaces include a region on which the contact surfaces are bonded to each other by an adhesive member.

7. The optical system according to claim 1 further comprising a third lens different from the first lens and the second lens,
wherein a following inequality is satisfied:
0.96<D1/D4<1.04,
where a minimum diameter of the third lens is D4.

8. The optical system according to claim 1, wherein a following inequality is satisfied:
1.00≤Dmax/Dmin<1.04,
where a maximum value and a minimum value of maximum diameters of lenses including the first lens and the second lens constituting the optical system and the interval holding member are Dmax and Dmin, respectively.

9. The optical system according to claim 8, wherein an object-side surface of a lens disposed on an object side farthest from an image side in the optical system is an aspheric surface.

10. The optical system according to claim 9, wherein the aspheric surface includes a point of inflection in a cross section including an optical axis.

11. The optical system according to claim 10, wherein curvatures with respect to points in a radial direction in a cross section including the optical axis of the aspheric surface have a minimum value.

12. The optical system according to claim 11, wherein a following inequality is satisfied:
0.50≤E≤0.80,
where E is a normalized distance from the optical axis to a point corresponding to the minimum value on the aspheric surface.

13. The optical system according to claim 1, wherein a following inequality is satisfied:
1.00<f×sin(θmax)/y(θmax)≤1.90,
where a projection property of the optical system representing a relationship between a half angle of view θ and an image height y is y(θ), a maximum half angle of view of the optical system is θmax, and a focal length of the optical system is f.

14. An optical apparatus comprising:
the optical system according to claim 1; and
a lens barrel configured to support the optical system.

15. The optical apparatus according to claim 14, wherein a following inequality is satisfied:
2.00<| T−αL|<30.0,
where a linear expansion coefficient of the lens barrel is αT [10⁻⁶/° C.] and a minimum value of linear expansion coefficients of lenses including the first lens and the second lens included in the optical system is αL [10⁻⁶/° C.].

16. The optical apparatus according to claim 15, wherein an internal shape of the lens barrel is circular.

17. An image capturing apparatus comprising:
the optical system according to claim 1; and
an element configured to capture an image of an object via the optical system,
wherein the element includes a pixel including a plurality of light receiving portions,
wherein the plurality of light receiving portions receive a light flux that has passed through different pupil points.

18. An in-vehicle system comprising:
the image capturing apparatus according to claim 17; and
a display apparatus configured to display an image obtained based on an output of the image capturing apparatus.

19. The in-vehicle system according to claim 18, wherein the display apparatus includes:
a first unit configured to display a first image corresponding to a first angle of view in the image; and
a second unit configured to display a second image corresponding to a second angle of view including the first angle of view.

20. A moving apparatus comprising the image capturing apparatus according to claim 17,
wherein the moving apparatus is movable while holding the image capturing apparatus.
